(19) United States
(12) Patent Application Publication
(10) Pub. No.: US 2009/0266480 A1
(43) Pub. Date: Oct. 29, 2009

(54) Process for Preparing a Solder Stand-Off

(75) Inventors: Steven A. Cordes, Yorktown Heights, NY (US); Peter A. Gruber, Mohegan Lake, NY (US)

Correspondence Address: Leander F. Aulisio, 320 23rd Street S. #705, Arlington, VA, 22202, US

(73) Assignee: INTERNATIONAL BUSINESS MACHINES CORPORATION, Armonk, NY (US)

(21) Appl. No.: 12/111,915

(22) Filed: Apr. 29, 2008

(51) Int. Cl. B32B 38/04

(52) U.S. Cl. 156/257

(57) ABSTRACT

The present invention relates to an injection molding of solder (IMS) process for preparing heterogenous solder bumps that contain a stand-off feature.

The present invention relates to the field of injection molding of solder. More particularly, it relates to a process for preparing a heterogeneous solder bump comprising a rigid stand-off material.

### BACKGROUND OF THE INVENTION

The increasing semiconductor device density and decreasing device dimensions require more stringent techniques for packaging and interconnecting such devices. A conventional method of packaging semiconductor devices is the flip-chip attachment method. The IC (integrated circuit) chip is not attached to a lead frame in a package. Instead, an array of solder balls is formed on the surface of the die. The array of solder balls serves as points of connection to conductive bonding pads on circuit carrying substrate and the like.

There are various methods of forming an array of solder balls. The evaporation method of forming the array of solder balls has been used in the past. Generally, the method includes the evaporation of lead and tin through a mask for producing the solder balls.

Another method of depositing solder balls is the solder paste screening method. Pastes are generally composed of a flux and solder alloy particles. There is a large reduction in volume when the screened paste is formed into a solder ball.

A more recent method of preparing an array of solder balls or bumps is the injection molding of solder (IMS) technique. Molten solder, rather than paste, is dispensed. U.S. Pat. No. 5,244,143 relates to a process for IMS. In the IMS process, there is only a very small reduction in volume when the molten solder is formed into a solder ball.

Japanese Patent Publication No. 2000-91371 discloses a pillar-shaped metal bump that may be embedded within a solder bump to absorb stresses applied to the solder bump. A solder layer for the solder bump may be formed on the pillar-shaped metal bump filled in an aperture part of a photoresist film. Thus, the solder layer may be shaped into a mushroom over the photoresist film so that the finished solder bump meets the desired size requirements.

US Patent Application Publication No. 2005/0090089, submitted by Ma et al, and U.S. Pat. No. 7,300,864, issued to Ma et al, relate to the formation of metal projections which are embedded within a solder bump. A dual exposure technique of a photoresist is employed. The photoresist is preferably a positive photoresist. The photoresist can be coated on an IC chip. First openings are formed at first exposed regions of the photoresist. A plurality of metal projections is then formed in the first openings. A second opening is then formed at a second exposed region of the photo resist by a second exposure process. The second exposed region can include non-exposed regions defined by the first exposure process. A solder material is then added to the second opening, and can be reflowed to form a solder bump. Metal projections are embedded in the solder bump.

US Patent Application Publication No. 2002/0151164, submitted by Jiang et al relates to a method for depositing solder bumps on a circuit containing substrate containing conductive regions. The method comprises forming a dielectric layer on the circuit substrate, patterning the dielectric layer, forming visa or holes to expose the conductive regions, and disposing a solder bump on the conductive regions. The method further comprises disposing a barrier layer on each of the solder bumps, and forming a second solder bump on each of the first solder bumps. In an alternative process, solder bumps are initially disposed on each of the conductive regions. The bumps are then covered with a dielectric material. Subsequently, the dielectric material and a portion of the solder bumps are removed. A barrier layer is then disposed on each of the remaining structures of the solder bumps. The second solder bump material can then be disposed on the barrier layer. Articles produced by the method include semiconductor substrates having stacked solder bumps and wafers having stacked solder bumps. The second solder bump has a lower melting point than the first solder bump.

None of the above cited references, taken either alone or in combination, serve to anticipate the present invention as herein disclosed and claimed.

### SUMMARY OF THE INVENTION

The present invention relates to a process for preparing rigid supports, called stand-offs, in solder bumping compositions. By employing the process of the present invention, mechanical properties of the solder bumping compositions can be adjusted to meet strength requirements. Electrical properties, such as reduced resistance, can also be adjusted to meet specific electrical requirements. In another embodiment of the present invention, the need for an under fill material can be reduced or eliminated.

The invention relies on the use of two different materials to form the solder bumps. One of the materials is for bonding and the other is for rigidity. An embodiment of the present invention is a process for preparing a solder stand-off containing a rigid material of metal or polymer. Preferably, the metal is copper or a copper alloy. Other metals or metal alloys can also be employed. The polymer must be a material that is rigid enough under process and operational conditions to function as a stand-off. Examples of polymers include polyamides, polyimide-amides and the like.

An embodiment of the present invention is a process for preparing a solder ball containing a stand-off by employing an arrangement of two different types of solder. One type of solder is employed for rigidity, and the other type of solder, having a lower melting point, is used for bonding. An example of this embodiment is obtaining an IC chip having an active area, forming under bump metal (UBM) layers on the chip, and coating a polymer layer over the UBM layers. The polymer layer is then etched or ablated to obtain a first hole or via over the UBM layer. In a preferred embodiment, the first hole or via is formed as by laser ablation. The hole or via is then filled with a first solder composition having a specified melting point. The IMS technique is employed to fill the first hole or via with the first solder composition. This first solder composition will act as a stand-off. A second hole or via is then formed in the polymer layer. The second hole or via is larger than, and substantially concentric with, the first hole or via. The aperture formed by the first solder composition and the sides of the second hole or via is then filled with a second solder composition. Again, the IMS technique is employed to deliver the second solder composition to the annular space between the first solder composition and the walls of the second hole or via. The second solder composition has a melting point that is substantially lower than the melting point of the first solder composition. The first solder composition is thus substantially coaxial with the second solder composition. The chip is now ready to be packaged as by flip-chip technology or the like. In the packaging process, the second solder composition is made molten as by heating the composition. The temperature of the heating process must not reach the melting point temperature of the first solder composition.

### DESCRIPTION OF THE DRAWINGS

FIG. 1 is a representation of a process for preparing a stand-off core wherein copper is employed as the stand-off material, and wherein the substrate employed is a sacrificial substrate.

FIG. 2 is a representation of a process for preparing a recessed stand-off core wherein copper is employed as the stand-off material, and wherein the substrate is a sacrificial substrate.

FIG. 3 is a representation of a process for preparing an encased stand-off core wherein copper is employed as the stand-off material, and wherein the substrate is a sacrificial substrate.

FIG. 4 is a representation of a process for preparing a concentric “dual solder” stand-off core wherein a high-melting solder is employed as the stand-off material, and wherein the substrate is a sacrificial substrate.

FIG. 5 is a representation of a process for preparing a concentric “dual solder” stand-off directly on a circuit carrying substrate, wherein a high-melting solder is employed as the stand-off material.

FIG. 6 is a representation of a process for preparing a polymeric stand-off directly on a circuit carrying substrate.

FIG. 7 is a representation of a process for preparing a concentric “dual solder” stand-off core wherein a high-melting solder is employed as the stand-off material, and wherein the substrate is an IMS mold for application of molten solder material to a circuit carrying substrate.

FIG. 8 is a representation of a process for preparing a stand-off core wherein copper is employed as the stand-off material, and wherein the substrate employed is an IMS mold for application of molten solder material to a circuit carrying substrate.

### DETAILED DESCRIPTION OF THE INVENTION

Applicant has introduced a solder bump structure having both bonding and rigidity characteristics. This solder bump structure includes a rigid stand-off material that allows for structural integrity between two separate substrates.

Solder bumps of the present invention are preferably formed by the IMS (injection molding of solder) technique. The IMS method generally utilizes a solder head that fills a boro-silicate glass mold. The mold is wide enough to cover wafers up to 300 mm. diameter. A molten solder is applied to a substrate by means of a transfer process. Even if the substrate is of a small size, for example, chip scale or single chip modules, the transfer step can be accomplished because the solder-filled mold can be readily aligned with the substrate.

The solder employed in the IMS method has a dual function. It forms the electrical connection between the semiconductor device chip (die) and the packaging material (ceramic module, organic package and the like). The solder also forms the mechanical connection between the chip and the packaging material. The mechanical properties of the solder can be controlled by adjusting the ingredients in the solder composition. Some mechanical properties are: tensile strength, ductile strength and surface tension. Some of these properties play a critical role in determination of the stand-off height. The stand-off height refers to the distance in separation between the chip and the packaging material. When under no-load conditions, the stand-off height is determined mainly by the surface tension of the solder material. But under load conditions, the distance can become very small, even to the point of contact of the nearest surfaces of the chip and packaging material. Contact between the two surfaces can destroy the integrity of the chip.

An embodiment of the present invention is a process for preparing a laminate comprising a silicon wafer having an active area and a circuit carrying substrate. The process comprises obtaining a sacrificial substrate comprising a bottom layer of glass, an intermediate layer comprising a plate of a first dielectric polymeric material, and a top layer of copper metal; coating the top layer of the sacrificial substrate with a layer of a second polymeric dielectric material; and forming a plurality of first openings in the layer of second polymeric dielectric material by performing an operation selected from the group consisting of RIE (reactive ion etching) and laser ablation. The plate of first dielectric polymeric material is preferably made of Kapton™ polyimide polymer. The intermediate layer comprising the plate of the first dielectric material is relatively thick, having a thickness of about 1 mm. to about 3 mm. The process further comprises filling the plurality of first openings with a substantially rigid material selected from the group consisting of copper, a copper alloy, and a first solder composition; forming a plurality of second openings in the layer of second polymeric dielectric material by performing an operation selected from the group consisting of RIE and laser ablation, wherein the plurality of second openings are substantially coaxial with the plurality of first openings; and filling the plurality of second openings with a second solder composition. In an alternative embodiment, the plurality of second openings are not substantially coaxial with the plurality of first openings. However, the plurality of first openings are contained within the plurality of second openings. The second solder composition has a melting point lower than the melting point of the first solder composition. The filling of the plurality of second openings with the second solder composition is obtained by injection molding of solder (IMS). Further, the second solder composition is substantially coaxial with the substantially rigid material. The process further comprises contacting the sacrificial substrate with a silicon wafer having an active area and conductive bonding pads. The filled openings of the sacrificial substrate are aligned with the conductive bonding pads of the silicon wafer. The process further comprises removing the bottom layer of glass, removing the intermediate layer comprising the plate of first dielectric polymer, and removing the top layer of copper metal to obtain a silicon wafer having a plurality of filled openings. The process further comprises obtaining a circuit carrying substrate comprising conductive bonding pads; contacting the circuit carrying substrate with the silicon wafer to form a laminate, whereby conductive bonding pads of the circuit carrying substrate are aligned with the plurality of filled openings on the silicon wafer; and heating the laminate at a temperature below the melting point of the first solder composition but above the melting point of the second solder composition to obtain the laminate comprising a silicon wafer having an active area and a circuit carrying substrate.

The present invention relates generally to electronic packaging technology and, more particularly, to heterogeneous solder bump structures that may be used for flip chip packages or wafer level packages. As integrated circuits (IC) advance toward higher speeds and larger pin counts, first-level interconnection techniques employing wire bonding technologies may have approached or even reached their limits. For example, technologies for achieving fine-pitch wire bonding structures may not keep pace with the demand resulting from increased IC chip processing speeds and higher IC chip pin counts. As such, a current trend may involve replacing wire bonding structures with other package structures, such as flip chip packages or wafer level packages. Flip chip packages and wafer level packages may employ solder bumps, which connect to interconnection terminals of the IC chips. A conventional solder bump structure is mounted on a circuit substrate.

An IC chip is usually equipped with a plurality of chip pads. Openings may be defined in one or more passivation layers to expose surfaces of the chip pads. One or more under bump metal (UBM) layers may be interposed between a solder bump and the chip pad. The UBM layers may function to reliably secure the solder bump to the chip pad, and to prevent moisture absorption into the chip pad. and the IC chip. Typically, the first UBM layer may function as an adhesion layer and may be deposited by sputtering of Cr, Ti, or TiW. Also typically, the second UBM layer may function as a solder wetting layer and may be deposited by sputtering of Cu, Ni, or NiV. The UBM layer, or an intermediate layer therebetween, may function as a solder diffusion barrier. Further, another layer may be optionally deposited on the UBM layers or the intermediate layer for oxidation prevention purposes.

The flip chip package or the wafer level package may be mounted on a circuit substrate via the solder bumps. The circuit substrate may have a plurality of substrate pads corresponding to the chip pads of the IC chip. The respective solder bumps may provide solder joints between both pads.

The solder layer may be fabricated from at least one of Sn, Pb, Ni, Au, Ag, Cu, Bi, alloys thereof. The UBM layer may include a lower UBM layer acting as an adhesion layer and an upper UBM layer acting as a solder wetting layer.

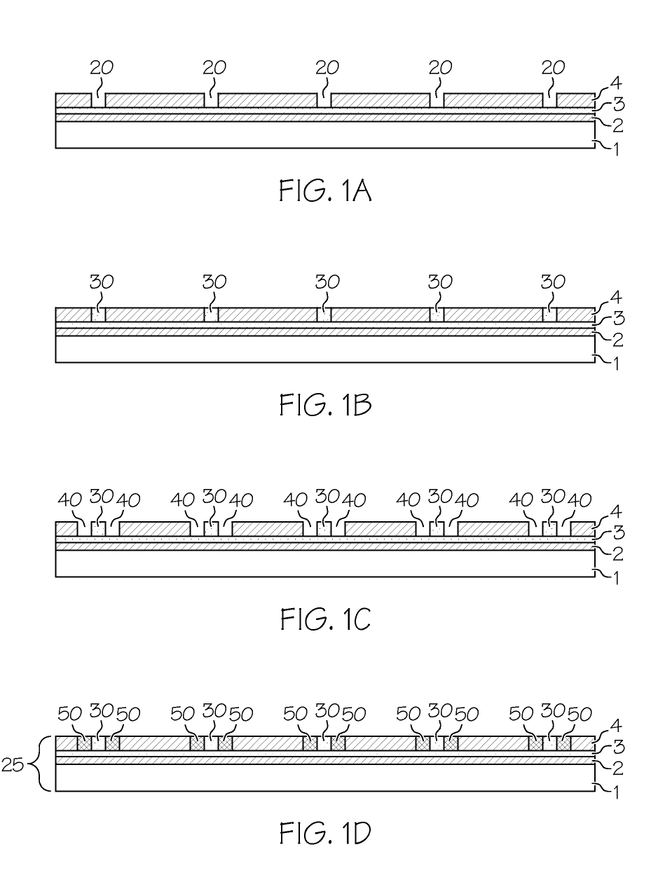

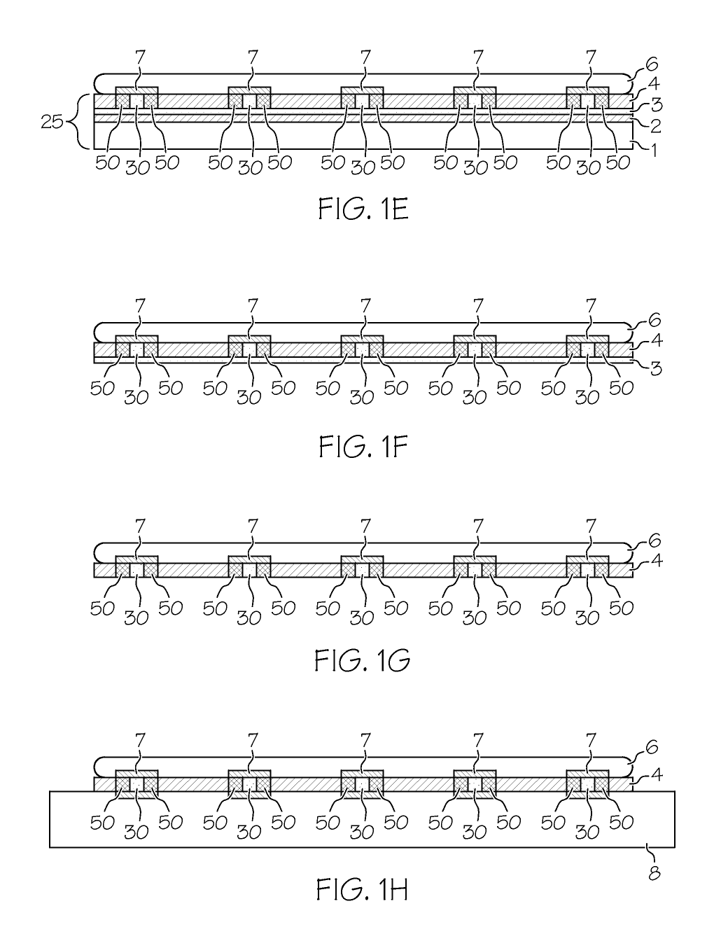

Referring to FIG. 1, a plated stand-off core 25 is prepared by a process comprising obtaining a substrate comprising a laminate of glass 1, polyimide polymer 2, and copper metal 3. A layer 4 of polyimide polymer is coated onto the surface of the copper metal 3. In one embodiment, the layer 4 of polyimide polymer is a solid Kapton polyimide polymer. In an alternative embodiment, the layer 4 of polyimide can be applied as a liquid material and then cured. The layer 4 of polyimide polymer is then etched to obtain a first set of holes or vias 20 that extend to the copper metal layer 3. The etching is performed by reactive ion etching (RIE) or by laser ablation. The holes or vias 20 are then filled with a copper metal 30 which is to act as a stand-off material. A second etching procedure is then performed on the polyimide layer 4 to obtain a second set of holes and vias 40 that circumscribe the first set of holes and vias 20, now filled with the copper metal 30. A molten solder composition 50 is then flowed into the second set of holes or vias 40. The IMS method is employed to add the solder composition 50 to the holes or vias 40. The result is that the solder composition 50 circumferentially surrounds the copper metal 30, thus forming a solder bump containing a stand-off feature. The solder composition 50 is coaxial with the copper metal 30. The copper metal 30 forms the stand-off.

A silicon wafer substrate 6, containing conductive bonding pads 7, is then placed over the stand-off core 25. The solder bumps, comprising the solder composition 50 and the copper metal stand-off 30, are aligned with bonding pads 7. The combination of silicon wafer substrate 6 and the stand-off core 25 is then heated to a temperature sufficient to melt the solder composition 50. The silicon wafer 6 is thus bonded to the stand-off core 25. After cooling, the glass layer 1 and the polyimide layer 2 are removed. The copper metal layer 3 is then removed from the bonded substrates. The polyimide layer 4 remains on the silicon wafer substrate 6. In an alternative embodiment, the polyimide layer 4 is removed to obtain a silicon wafer 6 containing an array of heterogeneous solder bumps. Finally, the silicon wafer 6 is aligned with a circuit carrying substrate 8 as by matching up the bonding pads, and attached to the circuit carrying substrate 8 as by reflow of the array of heterogeneous solder bumps. The heterogeneous solder bumps comprise the solder composition 50 and the copper metal stand-off 30. If the polyimide layer 4 is removed, then an underfill of epoxy or the like can be added between the silicon wafer 6 and the circuit carrying substrate 8 as by capillary action.

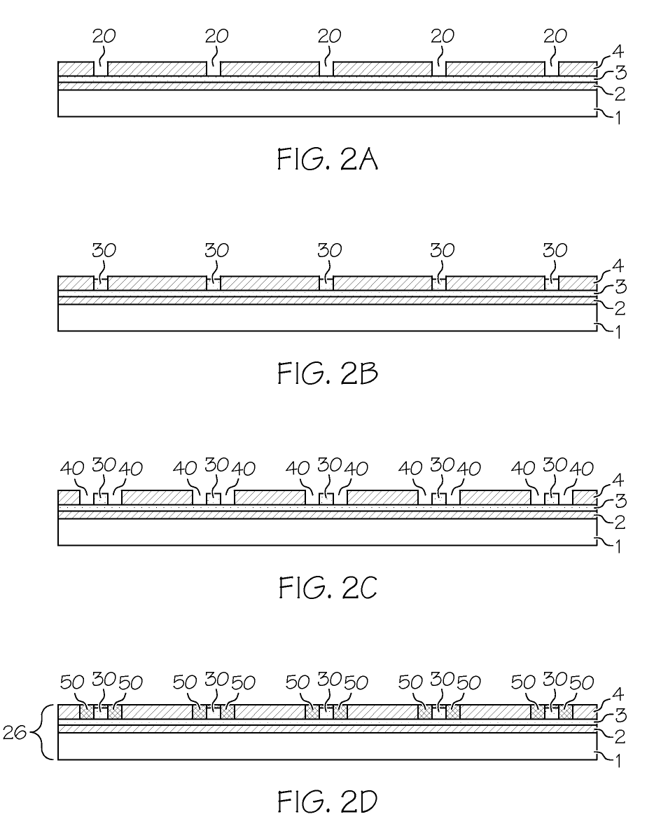

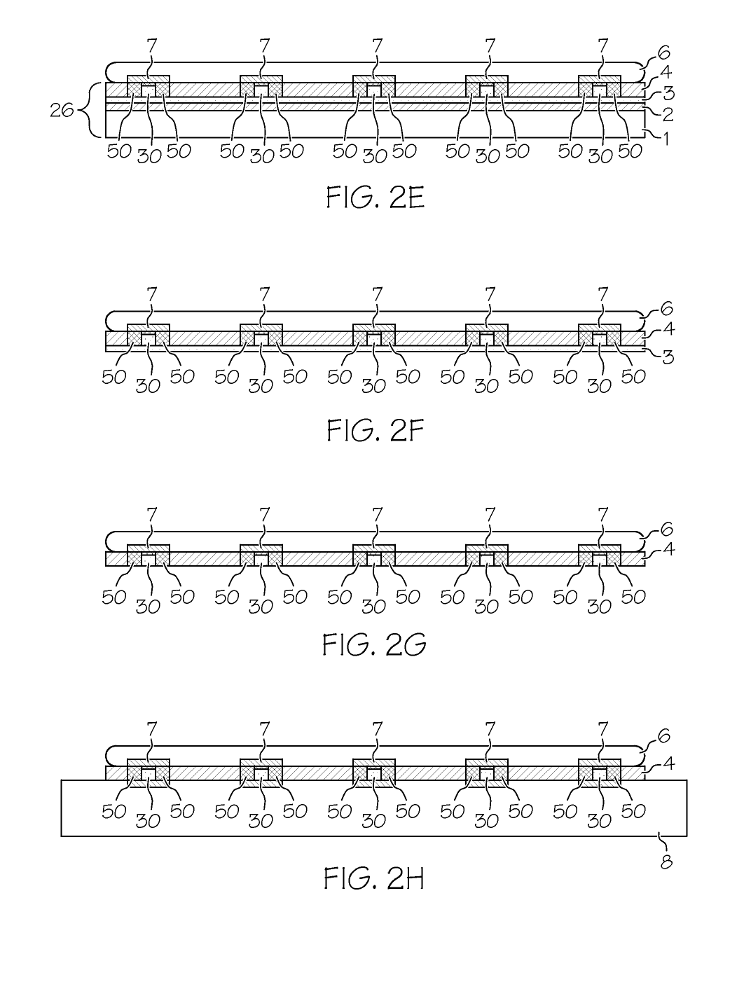

Referring to FIG. 2, a recessed stand-off core 26 is prepared by a process comprising obtaining a substrate comprising a laminate of glass 1, polyimide polymer 2, and copper metal 3. A layer 4 of polyimide 4 is coated onto the surface of the copper metal 3. The polyimide layer 4 is then etched to obtain a first set of holes or vias 20 that extend to the copper metal layer 3. The etching is performed by reactive ion etching (RIE) or by laser ablation. The holes or vias 20 are then incompletely filled with a copper metal 30 which is to act as a stand-off material. The copper metal 30 does not completely fill the holes or vias 20, but only fills part of the holes or vias 20. The amount of copper metal 30 in the holes or vias can be anywhere from about 50% of total capacity to about 90% of total capacity of the holes or vias 20. A second etching procedure is then performed on the polyimide layer 4 to obtain a second set of holes and vias 40 that circumscribe the first set of holes and vias 20, now incompletely filled with the copper metal 30. A molten solder composition 50 is then flowed into the second set of holes or vias 40. The IMS method is employed to fill the holes or vias 40 with the solder composition 50. The result is that the copper metal 30 is encapsulated by the solder composition 50, except for the foot of the copper metal 30, which is directly attached to the copper metal layer 3. The copper metal 30 functions as a stand-off material. The solder composition 50 is coaxial with the copper metal 30, and also forms a cap over the copper metal 30. A heterogeneous solder bump is thus obtained.

A silicon wafer substrate 6, containing conductive bonding pads 7, is then placed over the recessed stand-off core 26. The heterogeneous solder bump, comprising the solder composition 50 and the copper metal stand-off 30, is aligned with the bonding pads 7 of the silicon wafer substrate 6. The laminate of silicon wafer substrate 6 and the recessed stand-off core 26 is then heated to a temperature sufficient to melt the solder composition 50. The silicon wafer 6 is thus bonded to the stand-off core 26. After cooling, the glass layer 1 and the polyimide layer 2 are removed. The copper metal layer 3 is then removed from the bonded substrates. Finally, the so-modified silicon wafer 6 is attached to a circuit carrying substrate 8 as by reflow of the array of solder bumps containing the solder composition 50 and the copper metal stand-off 30.

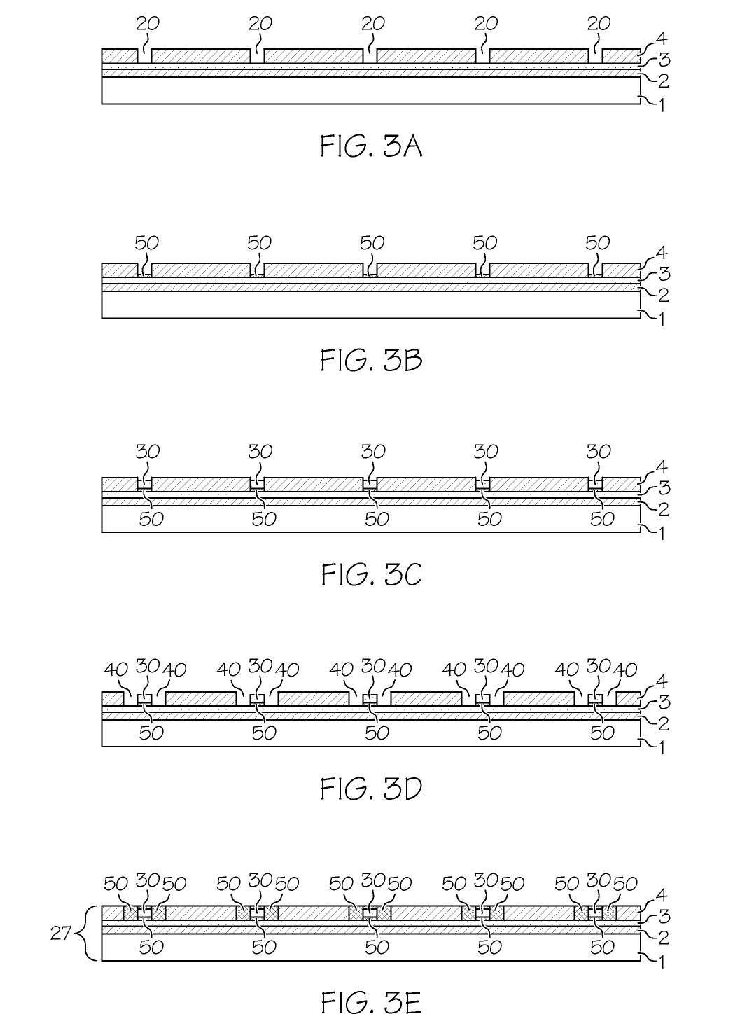

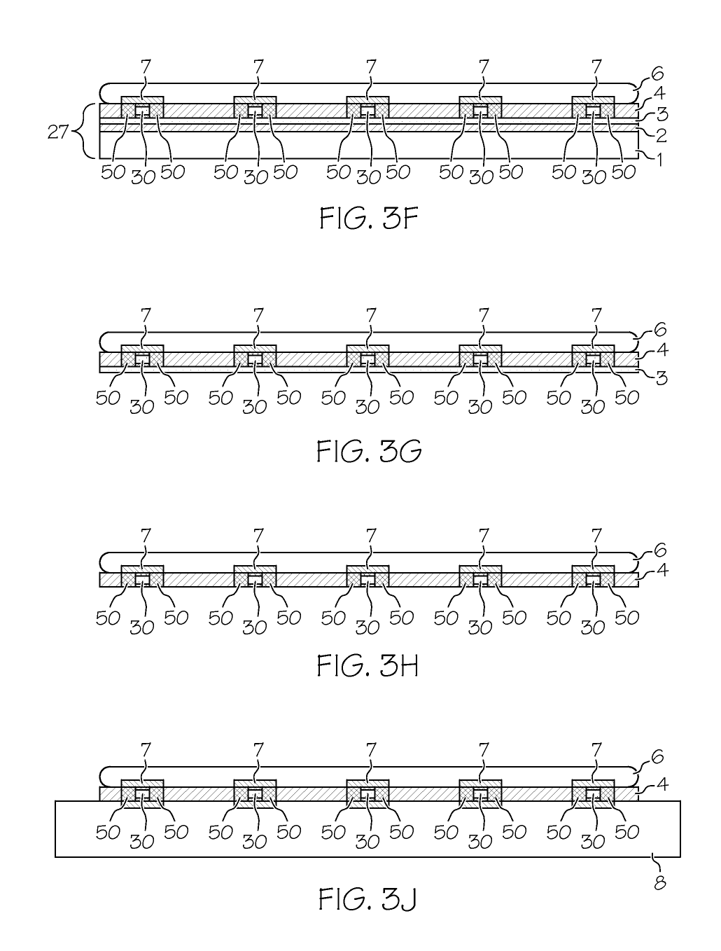

Referring to FIG. 3, an encased stand-off core 27 is prepared by a process comprising obtaining a substrate comprising a laminate of glass 1, a polyimide polymer plate 2, and copper metal 3. A layer of polyimide 4 is coated onto the surface of the copper metal 3. The layer 4 is then etched to obtain a first set of holes or vias 20 that extend to the copper metal layer 3. The etching is performed by reactive ion etching (RIE) or by laser ablation. The bottom of the holes or vias 20 is then plated with a molten layer of solder material 50 as by a plating method or the like. The molten solder material 50 covers only the bottom of the holes or vias 20. The coverage of the bottom can be anywhere from about 2% of the volume to about 10% of the volume of the holes or vias 20. The holes or vias 20 are then incompletely filled with a copper metal 30 which is to act as a stand-off material. The copper metal 30 does not completely fill the holes or vias 20, but only fills part of the holes or vias 20. The amount of copper metal 30 in the holes or vias can be anywhere from about 50% of total capacity to about 90% of total capacity of the holes or vias 20. A second etching procedure is then performed on the polyimide layer 4 to obtain a second set of holes or vias 40 that circumscribe the first set of holes and vias 20, now incompletely filled with the base of solder material 50 and the copper metal 30. The molten solder composition 50 is then flowed into the second set of holes or vias 40 by employing the IMS method. The result is that the copper metal 30 is completely surrounded by the solder composition 50, thus substantially encapsulating the copper metal 30. The copper metal 30 functions as a stand-off material.

A silicon wafer substrate 6 is then placed over the recessed stand-off core 27. The solder bump, comprising the solder composition 50 and the copper metal stand-off 30, is aligned with the bonding pads 7 of the silicon wafer substrate 6. The laminate of silicon wafer substrate 6 and the recessed stand-off core 26 is then heated to a temperature sufficient to melt the solder composition 50, thus bonding the silicon wafer 6 to the stand-off core 27. After cooling of the laminate, the glass layer 1 and the polyimide layer 2 are removed. The copper metal layer 3 is then removed from the laminate. Finally, the silicon wafer 6 is attached to a circuit carrying substrate 8 as by reflow of the array of solder bumps containing the solder composition 50 and the copper metal stand-off 30.

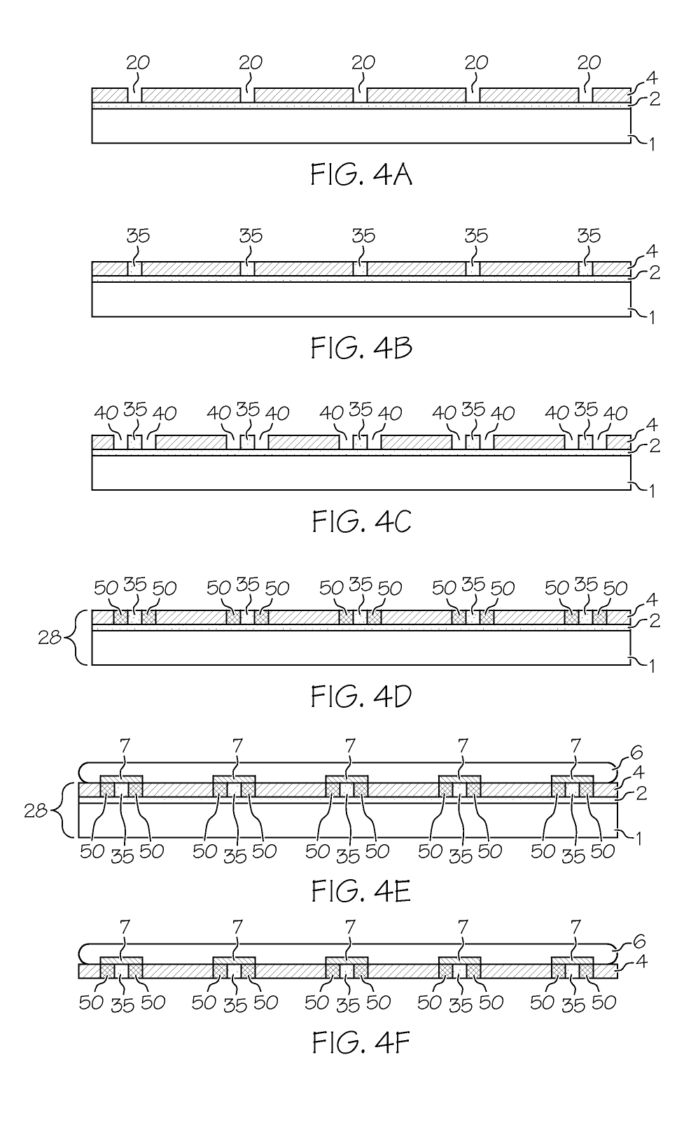

Referring to FIG. 4, a “dual solder” stand-off core 28 is prepared by a process comprising obtaining a substrate comprising a laminate of glass 1 and a polyimide polymer plate 2. A layer of polyimide 4 is coated onto the surface of the polyimide polymer plate 2. The polyimide layer 4 is then etched to obtain a first set of holes or vias 20 that extend to the polyimide polymer plate 2. The etching is performed by reactive ion etching (RIE) or by laser ablation. The holes or vias 20 are then filled with a first solder composition 35 which is to act as a stand-off material. Preferably, the IMS method is employed to fill the first set of holes or vias 20. A second etching procedure is then performed on the polyimide layer 4 to obtain a second set of holes and vias 40 that circumscribe the first set of holes and vias 20, now filled with first solder composition 35. A second solder composition 50, which has a melting point substantially lower than that of the first solder composition 35, is then flowed into the second set of holes or vias 40 by employing the IMS method. The result is that the second solder composition 50 circumferentially surrounds the solder composition 35, thus forming a “dual solder” solder bump containing a stand-off feature. The second solder composition 50 is coaxial with the first solder composition 35.

A silicon wafer substrate 6, containing conductive bonding pads 7, is then placed over the stand-off core 28. The heterogeneous solder bumps, comprising the solder composition 50 and the solder stand-off 35, are aligned with the bonding pads 7 of the silicon wafer substrate 6. The laminate of silicon wafer substrate 6 and the stand-off core 28 is then heated to a temperature sufficient to melt the solder composition 50, thus bonding the silicon wafer 6 to the stand-off core 28. After cooling, the glass layer 1 and the polyimide plate 2 are removed. Finally, the silicon wafer 6 is aligned with a circuit carrying substrate (not shown); and bonded as by reflow of the array of solder bumps containing the solder composition 50 and the solder stand-off 35.

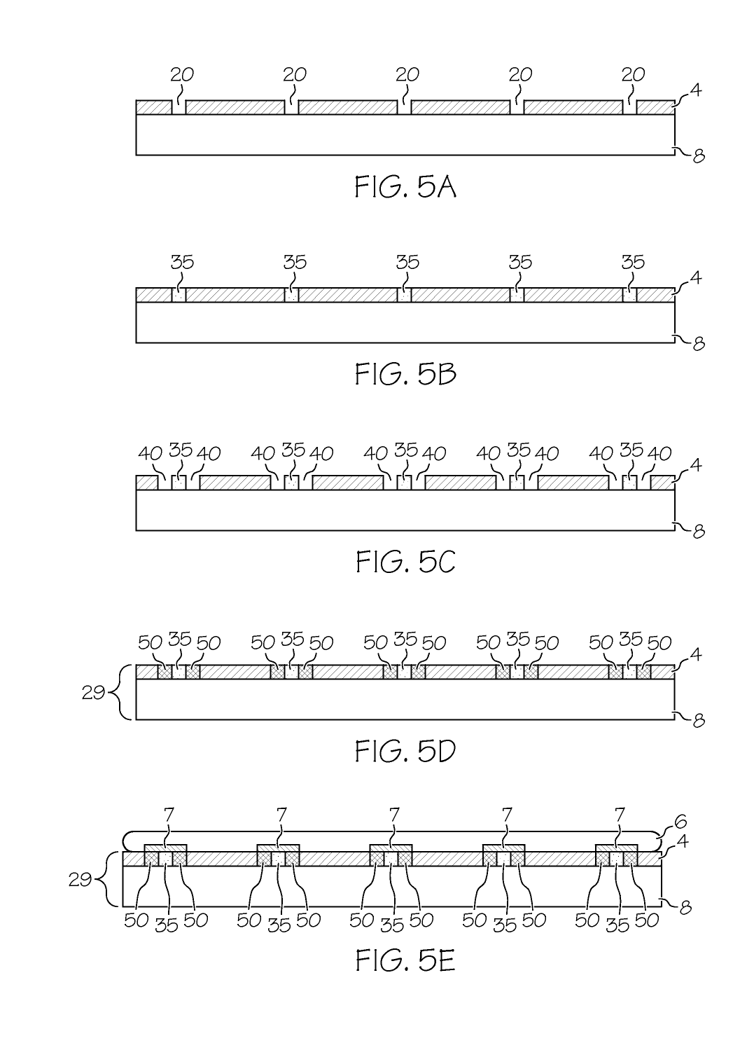

Referring to FIG. 5, a concentric “dual solder” stand-off core 29 is prepared by a process comprising obtaining a substrate comprising a current carrying substrate 8. A layer of polyimide 4 is coated onto the surface of the current carrying substrate 8. The polyimide layer 4 is then etched to obtain a first set of holes or vias 20 that extend to the current carrying substrate 8. Etching is performed by reactive ion etching (RIE) or by laser ablation. The holes or vias 20 are then filled with a first molten solder composition 35, which is to act as a stand-off material. Preferably, the IMS method is employed to fill the first set of holes or vias 20. A second etching procedure is then performed on the polyimide layer 4 to obtain a second set of holes or vias 40 that circumscribe the first set of holes or vias 20, now filled with first solder composition 35. A second molten solder composition 50, which has a melting point substantially lower than that of the first solder composition 35, is then flowed into the second set of holes or vias 40 by employing the IMS method. The result is that the second solder composition 50 circumferentially surrounds the solder composition 35, thus forming a “dual solder” solder bump containing a stand-off feature. The second solder composition 50 is substantially coaxial with the first solder composition 35.

A silicon wafer substrate 6 is then placed over the stand-off core 29. The solder bumps, comprising the solder composition 50 and the solder stand-off 35, are aligned with the bonding pads 7 of the silicon wafer substrate 6. The laminate of silicon wafer substrate 6 and the “dual solder” stand-off core 29 is then heated to a temperature sufficient to melt the solder composition 50, but not the solder composition 35; thus bonding the silicon wafer 6 to the stand-off core 29, which comprises the current carrying substrate 8.

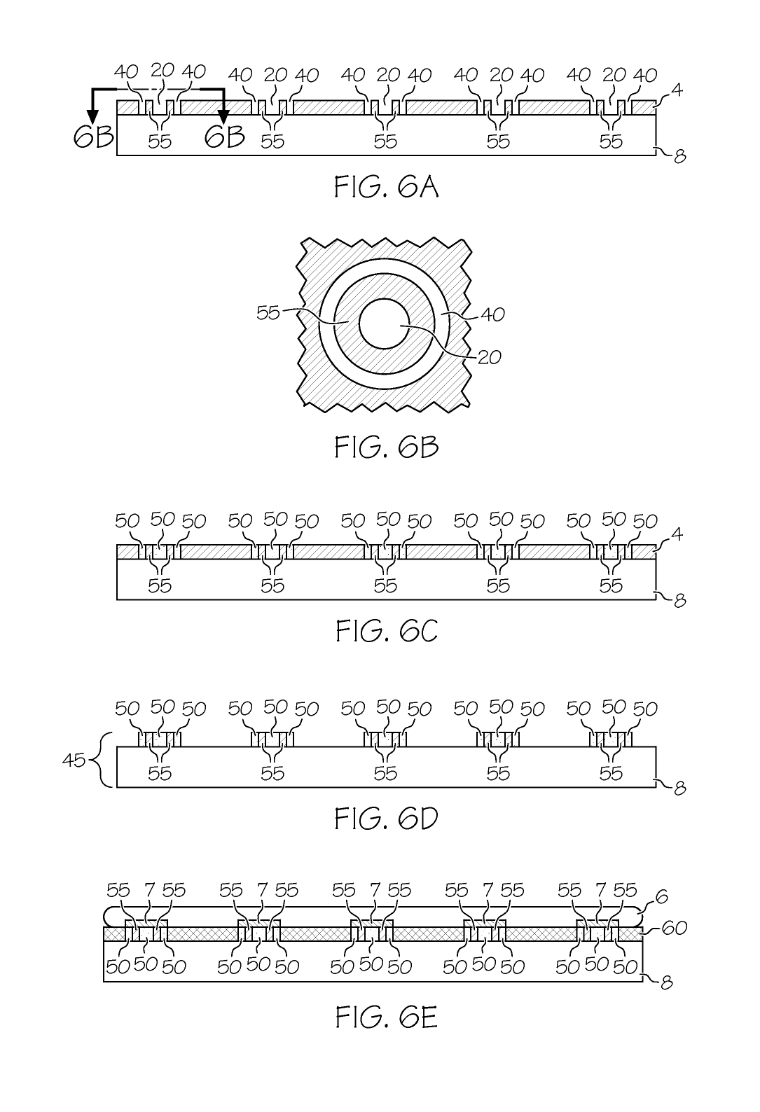

Referring to FIG. 6, a polymeric stand-off core 45 is prepared by a process comprising obtaining a substrate comprising a current carrying substrate 8. A layer 4 of polyimide polymer is coated onto the surface of the current carrying substrate 8. The polyimide layer 4 is then etched to obtain a first set of holes or vias 20 that extend to the current carrying substrate 8; and a second set of holes or vias 40. The second set of holes or vias 40 form an annular ring around the first set of holes or vias 20. Both sets of holes or vias are obtained in one etching operation. Alternatively, two etching operations can be performed. Etching is performed by reactive ion etching (RIE) or by laser ablation. The first set of holes or vias 20 and the second set of holes or vias 40, separated by a ring 55 of polyimide polymer, are then filled with a molten solder composition 50. Preferably, a single IMS process is employed to fill both the first set of holes or vias 20 and the second set of holes or vias 40. In the alternative, two separate IMS procedures can be performed. The alternative process requires that the steps of etch and fill must be performed twice. The ring 55 of polyimide polymer acts as a rigid polymeric stand-off material. The polyimide layer 4 can then be removed, except for the ring 55 of polyimide, to obtain a polymeric stand-off core 45, which comprises a current carrying substrate 8. The solder composition 50 is coaxial with the ring 55 of polyimide polymer.

A silicon wafer substrate 6 is then placed over the stand-off core 45. The solder bump, comprising the solder composition 50 and a ring 55 of polyimide polymer embedded therein, is aligned with the bonding pads 7 of the silicon wafer substrate 6. The laminate of silicon wafer substrate 6 and the polymeric stand-off core 29 is then heated to a temperature sufficient to melt the solder composition 50, thus bonding the silicon wafer 6 to the stand-off core 29. An underfill layer 60 of epoxy or the like is then added between the laminate layers, as represented by the ring 55 of polyimide polymer.

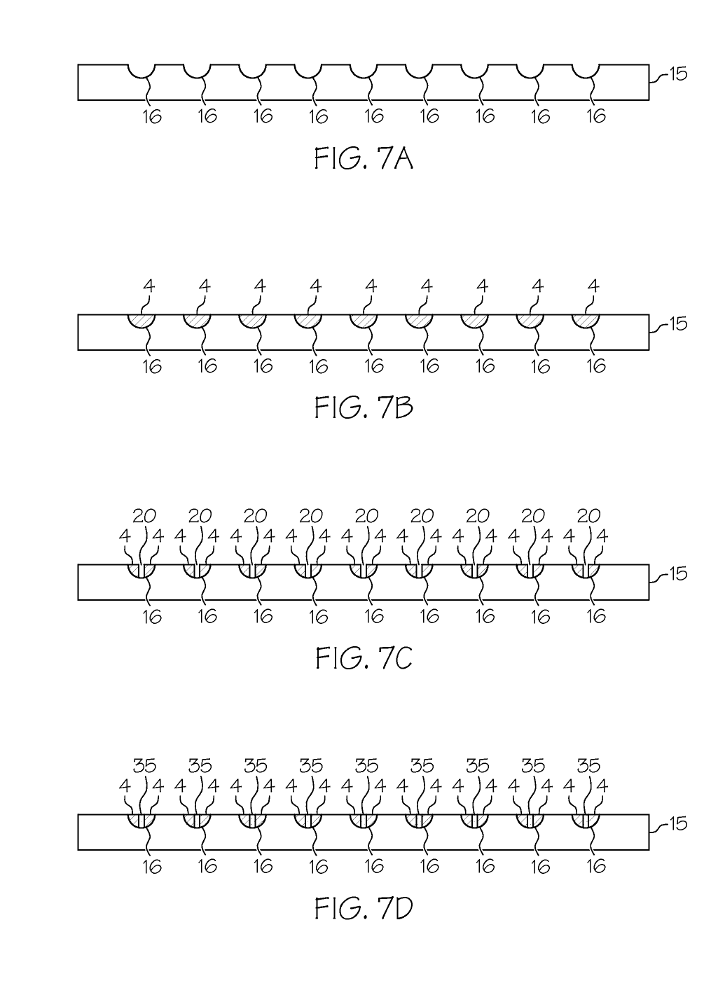

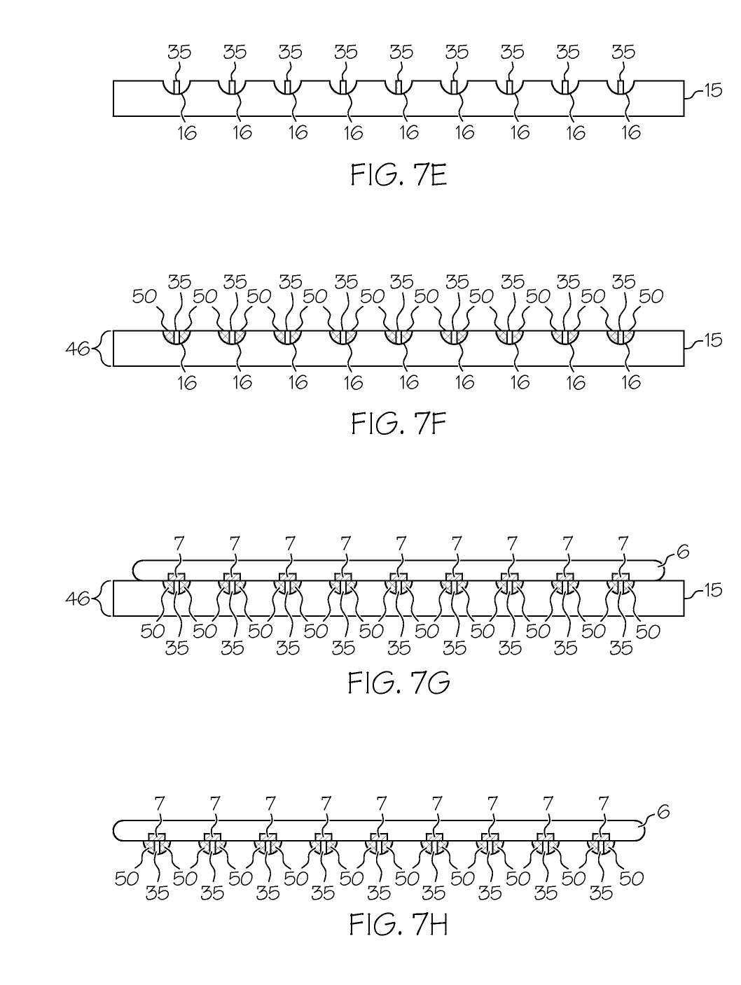

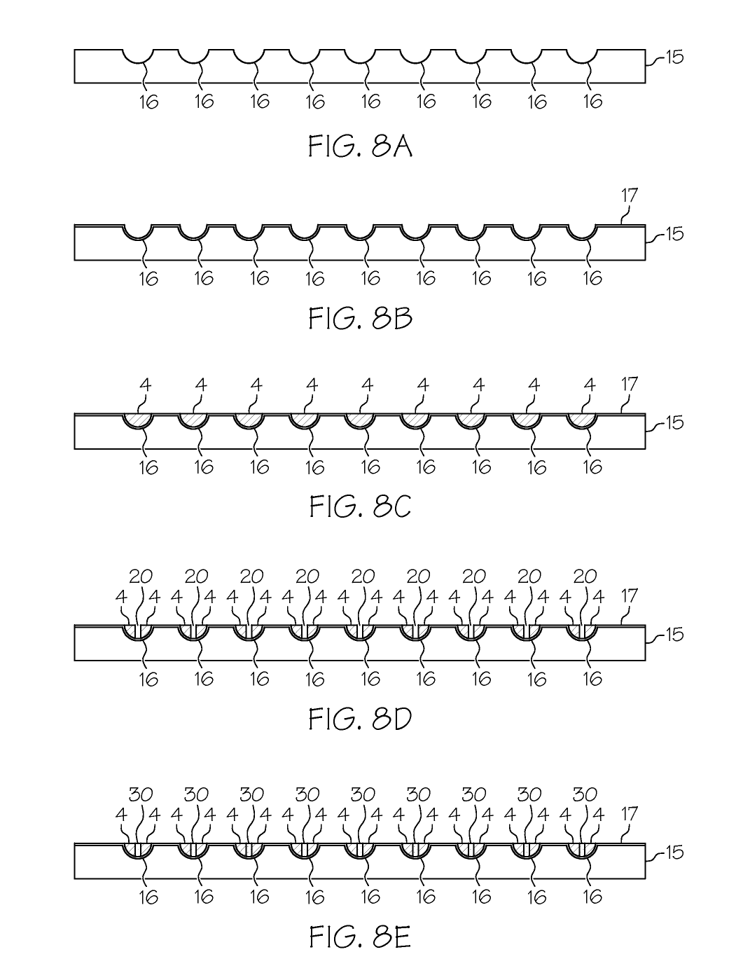

Referring to FIG. 7, a concentric “dual solder” stand-off mold 46 is prepared by a process comprising obtaining a substrate comprising an IMS (injection molding of solder) mold 15 containing a plurality of wells 16. A layer 4 of polyimide polymer is coated onto the surface of the wells 16. The polyimide layer 4 substantially fills the wells 16 of the IMS mold 15. The polyimide layer 4 is then etched to obtain a set of holes or vias 20 that extend to the base of the wells 16. Etching is performed by reactive ion etching (RIE) or by laser ablation. One hole or via 20 is formed for each well 16. The set of holes or vias 20 are then filled with a first solder composition 35. Preferably, the IMS method is employed to fill the set of holes or vias 20 with the molten solder composition 35. The remaining layer 4 of polyimide is then removed from the wells 16. Wells 16 are then filled with a second molten solder composition 50. The second solder composition 50 has a melting point substantially below that of the first solder composition 35. The second solder composition 50 is coaxial with the first solder composition 35.

A silicon wafer substrate 6 containing bonding pads 7 is then placed over the stand-off mold 46. The solder bumps, comprising the first solder composition 35 and the second solder composition 55, are aligned with the bonding pads 7 of the silicon wafer substrate 6. The IMS mold 15 is then activated to allow formation of solder bumps directly onto the pads 7 of the silicon wafer substrate 6. The “bumped” silicon wafer 6, containing an array of heterogeneous “dual solder” solder bumps, can then be bonded to a circuit carrying substrate or the like.

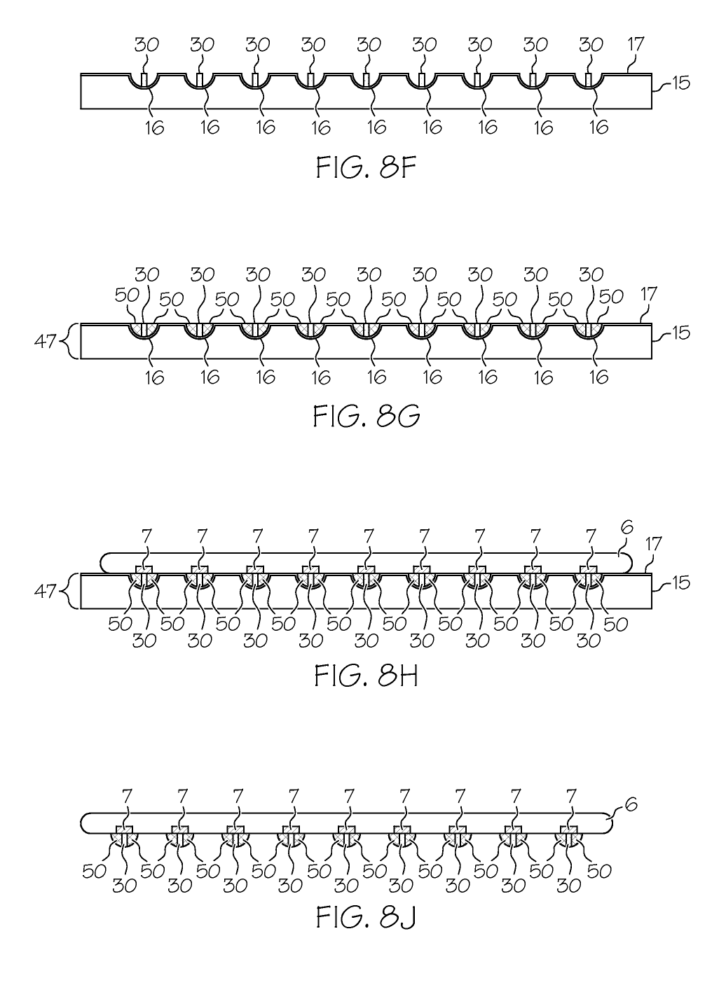

Referring to FIG. 8, a stand-off mold 47 is prepared by a process comprising obtaining a substrate comprising an IMS (injection molding of solder) mold 15 having a plurality of wells 16. A conductive plating layer 17, such as a layer of chromium/copper alloy, is deposited across the entire surface of the IMS mold 15, including the plurality of wells 16. A layer 4 of polyimide polymer is coated onto the surface of the wells 16. The polyimide layer 4 substantially fills the wells 16. The polyimide layer 4 is then etched to obtain a set of holes or vias 20 that extend to the base of the wells 16. Etching is performed by reactive ion etching (RIE) or by laser ablation. One hole or via 20 is formed for each well 16. The set of holes or vias 20 are then filled with a copper metal 30. Preferably, a plating method can be employed to fill the holes or vias 20 with copper metal 30. The remaining layer 4 of polyimide polymer is then removed from the wells 16. The removal of the layer 4 of polyimide polymer can be accomplished by means of wet etching, reactive ion etching or laser ablation. Wells 16 are then filled with a molten solder composition 50. Preferably, the IMS method is employed in filling the wells 16 with the solder composition 50. The solder composition 50 is coaxial with the copper metal 30. After the process, a stand-off mold 47 is obtained.

A silicon wafer substrate 6 containing bonding pads 7 is then placed over the stand-off mold 47. The solder bumps are aligned with the bonding pads 7 of the silicon wafer substrate 6. The IMS mold 15 is then activated to allow formation of heterogeneous solder bumps directly onto the pads 7 of the silicon wafer substrate 6. The “bumped” silicon wafer 6, containing an array of heterogeneous solder bumps, can then be bonded to a circuit carrying substrate or the like.

An embodiment of the present invention is a laminate comprising a silicon wafer having an active area and a circuit carrying substrate. The laminate is formed by a bonding process comprising obtaining a sacrificial substrate comprising a bottom layer of glass, an intermediate layer comprising a plate of first dielectric polymeric material, and a top layer of copper metal. The process further comprises coating the top layer of the sacrificial substrate with a layer of a second polymeric dielectric material; and forming a plurality of first openings in the layer of second polymeric dielectric material by performing an operation selected from the group consisting of RIE (reactive ion etching) and laser ablation. The process further comprises filling the plurality of first openings with a substantially rigid material selected from the group consisting of copper, a copper alloy, and a first solder composition; forming a plurality of second openings in the layer of second polymeric dielectric material by performing an operation selected from the group consisting of RIE and laser ablation, wherein the plurality of second openings are coaxial with the plurality of first openings; and filling the plurality of second openings with a second solder composition. The second solder composition has a melting point lower than the melting point of the first solder composition. The filling of the plurality of second openings with the second solder composition is obtained by injection molding of solder (IMS). Further, the second solder composition is coaxial with the substantially rigid material. The process further comprises contacting the sacrificial substrate with a silicon wafer having an active area and conductive bonding pads The filled openings of the sacrificial substrate are aligned with the conductive bonding pads of the silicon wafer. The process further comprises removing the bottom layer of glass, the intermediate layer of first dielectric polymer, and the top layer of copper metal to obtain a silicon wafer having a plurality of filled openings. The process further comprises obtaining a circuit carrying substrate; contacting the circuit carrying substrate with the silicon wafer to form a laminate, whereby conductive bonding pads of the circuit carrying substrate are aligned with the plurality of filled openings on the silicon wafer; and heating the laminate at a temperature below the melting point of the first solder composition but above the melting point of the second solder composition to obtain the laminate comprising a silicon wafer having an active area and a circuit carrying substrate.

An embodiment of the present invention is a laminate comprising a first layer of a silicon wafer having an active area and a second layer of a circuit carrying substrate. The laminate is prepared according to the following process. The process comprises obtaining a sacrificial substrate comprising a bottom layer of glass, an intermediate layer comprising a plate of a first dielectric polymeric material, and a top layer of copper metal; coating the top layer of the sacrificial substrate with a layer of a second polymeric dielectric material; and forming a plurality of first openings in the layer of second polymeric dielectric material by performing an operation selected from the group consisting of RIE (reactive ion etching) and laser ablation. The plate of first dielectric polymeric material is preferably made of Kapton™ polyimide polymer. The intermediate layer comprising the plate of the first dielectric material is relatively thick, having a thickness of about 1 mm. to about 3 mm. The process further comprises filling the plurality of first openings with a substantially rigid material selected from the group consisting of copper, a copper alloy, and a first solder composition; forming a plurality of second openings in the layer of second polymeric dielectric material by performing an operation selected from the group consisting of RIE and laser ablation, wherein the plurality of second openings are substantially coaxial with the plurality of first openings; and filling the plurality of second openings with a second solder composition. In an alternative embodiment, the plurality of second openings are not substantially coaxial with the plurality of first openings. However, the plurality of first openings are contained within the plurality of second openings. The second solder composition has a melting point lower than the melting point of the first solder composition. The filling of the plurality of second openings with the second solder composition is obtained by injection molding of solder (IMS). Further, the second solder composition is substantially coaxial with the substantially rigid material. The process further comprises contacting the sacrificial substrate with a silicon wafer having an active area and conductive bonding pads. The filled openings of the sacrificial substrate are aligned with the conductive bonding pads of the silicon wafer. The process further comprises removing the bottom layer of glass, the intermediate layer comprising the plate of first dielectric polymer, and the top layer of copper metal to obtain a silicon wafer having a plurality of filled openings. The process further comprises obtaining a circuit carrying substrate; contacting the circuit carrying substrate with the silicon wafer to form a laminate, whereby conductive bonding pads of the circuit carrying substrate are aligned with the plurality of filled openings on the silicon wafer; and heating the laminate at a temperature below the melting point of the first solder composition but above the melting point of the second solder composition to obtain the laminate comprising a silicon wafer having an active area and a circuit carrying substrate.

While the invention has been described by various embodiments and examples, there is no intent to limit the inventive concept except as set forth in the following claims.

We claim:

1. A process for preparing a laminate comprising a silicon wafer having an active area and a circuit carrying substrate, the process comprising:
obtaining a sacrificial substrate comprising a bottom layer of glass, an intermediate layer comprising a plate of a first dielectric polymeric material, and a top layer of copper metal;
coating the top layer of the sacrificial substrate with a second polymeric dielectric material to obtain a layer of second polymeric dielectric material;
forming a plurality of first openings in the layer of second polymeric dielectric material by performing an operation selected from the group consisting of RIE (reactive ion etching) and laser ablation;
filling the plurality of first openings with a substantially rigid material selected from the group consisting of copper, a copper alloy, and a first solder composition;
forming a plurality of second openings in the layer of second polymeric dielectric material by performing an operation selected from the group consisting of RIE and laser ablation, wherein the plurality of second openings are substantially coaxial with the plurality of first openings;
filling the plurality of second openings with a second solder composition, wherein the second solder composition has a melting point lower than the melting point of the first solder composition, and wherein the filling of the plurality of second openings with the second solder composition is obtained by injection molding of solder (IMS), and whereby the second solder composition is substantially coaxial with the substantially rigid material;
contacting the sacrificial substrate with a silicon wafer comprising an active area and conductive bonding pads, wherein the filled openings of the sacrificial substrate are aligned with the conductive bonding pads of the silicon wafer;
removing the bottom layer of glass;
removing the intermediate layer comprising the plate of the first dielectric polymeric material;
removing the top layer of copper metal to obtain a silicon wafer having a plurality of filled openings;
obtaining a circuit carrying substrate comprising conductive bonding pads;
contacting the circuit carrying substrate with the silicon wafer to form a laminate, whereby the conductive bonding pads of the circuit carrying substrate are aligned with the plurality of filled openings on the silicon wafer; and
heating the laminate at a temperature below the melting point of the first solder composition but above the melting point of the second solder composition to obtain the laminate comprising a silicon wafer having an active area and a circuit carrying substrate.
